(19) United States
(12) Patent Application Publication
(10) Pub. No.: US 2007/0038986 A1
(43) Pub. Date: Feb. 15, 2007

(54) Automation of Java application using enhanced late-bound support

(76) Inventor: Thomas M. Houser, Beaverton, OR (US)

Correspondence Address: WALTER W. DUFT, 8616 MAIN STREET, SUITE 2, WILLIAMSVILLE, NY, 14221, US

(21) Appl. No.: 11/204,130

(22) Filed: Aug. 15, 2005

(51) Int. Cl. G06F 9/45

(52) U.S. Cl. 717/151

(57) ABSTRACT

A Java/COM bridge provides enhanced late-bound COM-to-Java support. The Java/COM bridge allows a COM application to make a late bound call to a Java class in a Java application wherein the late bound call contains a parameter indicating that the Java class should not be instantiated. The Java/COM bridge returns to the COM application a static COM proxy representing the Java class without instantiating the Java class. Using the static COM proxy, the COM application can call static methods and reference static variables of the Java class. The COM application can also call constructors of the Java class that take parameters by passing the parameters without specifying a method. The Java/COM bridge will identify the Java class constructor based on the specified parameters and instantiate a Java object by calling the identified constructor with the specified parameters.

### BACKGROUND OF THE INVENTION

1. Field of the Invention

The present invention relates to bridging software for interoperating between disparate computer software models. More particularly, the invention concerns a Java-to COM bridge that allows a COM (Component Object Model) automated API (Application Program Interface) to invoke a Java API.

2. Description of the Prior Art

By way of background, most modern software applications provide a graphical user interface (GUI) that allows users to interact with the application. In addition, an automation/extensibility mechanism is often provided that allows users to interact with the application programmatically via documented application program interfaces (APIs). Users can call the APIs via scripts or via another application.

Applications that are developed for deployment on Windows ® (registered trademark of Microsoft Corporation (referred to hereinafter for convenience as “Windows” without the ® symbol)) NT/2K/XP systems typically implement an automation API using the Windows Component Object Model (COM). COM is a distributed, object-oriented system for creating binary software components that can interact with each other. This object-oriented model is the defacto standard on Windows Systems. Once an application (acting in a server role) has provided a COM-based automation API, other applications (acting in a client role) can automate the application using standard COM mechanisms (e.g. VBScript, etc.) to invoke the application's functionality. The process of one software component communicating with and/or controlling another software component using COM is thus referred to as “automation.”

The Java® (registered trademark of Sun Microsystems, Inc. (referred to hereinafter for convenience as “Java” without the ® symbol)) programming language provides an alternative software model that is also object oriented and can be implemented according to a client-server paradigm. Unfortunately, although Java technology has played a major role in the development of large-scale applications and components on Windows platforms, the interoperability (or “bridging”) between the two technologies remains a largely unresolved issue from a software integration standpoint. Java applications are at a distinct disadvantage in this area because Java is intended to be a platform/operating system independent portable language, and has no built-in support for COM, which is a Windows specific technology. Therefore Java/COM bridging technologies are an important requirement for all COM and Java applications that need to communicate with each other. Bridging refers to software that allows applications written according to one software model to invoke software written under a different software model.

Although there are bridging solutions that enable Java applications to make automated calls to COM APIs (Java-to-COM support), there is a lack of bridging software that allows a Java application to effectively expose its Java APIs via COM automation (COM-to-Java support). The Windows COM technology is designed in a way that requires a certain style of programming that is not necessarily always used in Java APIs. In particular, COM automation APIs are always accessed via object instances. The caller must first instantiate a COM object (defined as an object oriented class by the API) and then reference the object methods/properties via this object instance. Java APIs quite commonly have classes that are not intended to be instantiated (at least not directly). Thus, whereas Java classes use static methods (known as “constructors”) that return object instances, some of the classes that define such static methods are not always designed to be instantiated. Java APIs that do require direct instantiation often need constructor parameters for proper object initialization. In the COM environment, object creation and object initialization are often two distinct operations. The object creation operation is always unparameterized. Any object initialization that requires parameters must be handled via a separate operation (e.g., via a method call) following object instantiation.

To retrofit an existing Java application with COM automation support is often a daunting exercise for the reasons outlined above. The Java application developer is often required to re-design the application's APIs or provide alternate APIs that conform to COM requirements. Although existing Java/COM bridging technologies allow Java applications entry into the COM world, the Java application developer must still invest considerable effort to provide a useable automation API to provide COM client access to the Java interface.

It is to improvements in COM-to-Java bridging technologies the present invention is directed. In particular, what is needed is an improved COM-to-Java bridging technology that exposes noninstantiated Java class APIs to COM applications.

### SUMMARY OF THE INVENTION

The foregoing problems are solved and an advance in the art is obtained by a novel Java/COM bridge that provides enhanced late-bound COM-to-Java support. The Java/COM bridge allows a COM application to make a late bound call to a Java class in a Java application wherein the late bound call contains a parameter indicating that the Java class should not be instantiated. The Java/COM bridge returns to the COM application a static COM proxy representing the Java class without instantiating the Java class. Using the static COM proxy, the COM application can call static methods and reference static variables of the Java class. The COM application can also call constructors of the Java class that take parameters by passing the parameters without specifying a method. The Java/COM bridge will identify the Java class constructor based on the specified parameters and instantiate a Java object by calling the identified constructor with the specified parameters.

In an exemplary implementation of the invention, the Java/COM bridge provides a registration method whereby the Java application creates and registers a COM container object in a COM running object table. The COM container object maintains a reference to a Java classloader that loads the Java class. The COM container object also includes a method for instantiating a static COM object corresponding to the static COM proxy and initializing the static COM object so that it holds a reference to the Java class without instantiating the Java class. The static COM object further includes a method for calling static methods of the Java class. The static COM object further includes a method for referencing static variables of the Java class. The static COM object additionally includes a method for receiving parameters specified by the COM application without a method, searching for a constructor in the Java class that takes the parameters, instantiating a Java object from the Java class using the constructor and the parameters, and returning a COM proxy referencing the instantiated Java object.

### BRIEF DESCRIPTION OF THE DRAWINGS

The foregoing and other features and advantages of the invention will be apparent from the following more particular description of exemplary embodiments of the invention, as illustrated in the accompanying Drawings, in which:

FIG. 1 is a functional block diagram showing components of a Java/COM bridge constructed in accordance with the present invention, together with a java application and a COM application that interact with the Java/COM bridge;

FIGS. 2A and 2B represent a flow diagram showing a prior art technique for providing late bound Com-to-Java support;

FIG. 3 is a functional block diagram showing a java application registering itself in a COM running object table via a java runtime library and a COM runtime library associated with the Java/COM bridge;

FIG. 4 is a functional block diagram showing an IDispatch COM object provided by a COM runtime library and a corresponding IDispatch COM proxy provided by an operating system COM environment;

FIG. 5 is a flow diagram showing a prior art technique for handling a COM application call to a Java method;

FIG. 6 is a flow diagram showing modifications made to the prior art technique for providing late bound Com-to-Java support (as shown in FIGS. 2A and 2B) in order to support COM application access to noninstantiated Java classes in accordance with the present invention;

FIG. 7 is a flow diagram showing modifications made to the prior art technique for handling a COM application call to a Java method (as shown in FIG. 5) in order to support COM application calls to static Java methods in accordance with the present invention;

FIG. 8 is a flow diagram showing enhancements made to the prior art technique for handling a COM application call to a Java method (as shown in FIG. 5) in order to support COM application calls to Java constructors that take parameters in accordance with the present invention;

FIG. 9 is a diagrammatic illustration of storage media that can be used to store a computer program product for implementing a Java/COM bridge in accordance with the invention; and

FIG. 10 is a functional block diagram showing a data processing system that can be used to implement a Java/COM bridge in accordance with the invention.

### DETAILED DESCRIPTION OF EXEMPLARY EMBODIMENTS

I. Introduction

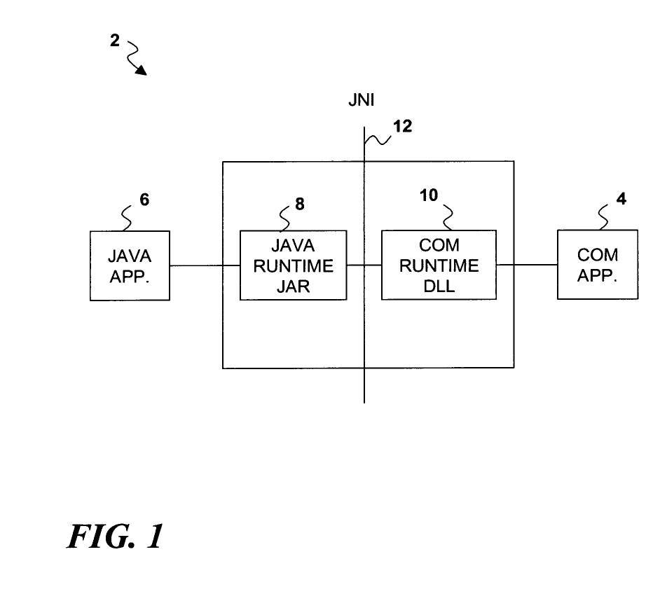

Turning now to the drawing figures wherein like reference numbers indicate like elements in all of the several views, FIG. 1 illustrates a Java/COM bridge 2 that allows a COM application 4 to invoke an automated API associated with a Java application 6 even though the latter includes objects that are not intended to be instantiated. The Java/COM bridge 2 comprises a Java runtime library 8 and a COM runtime library 10. The Java side of the Java/COM bridge 2 is shown as being separated from the COM side of the Java/COM bridge by an interface 12 labeled “JNI.” The term JNI refers to the Java Native Interface provided by the Java Development Kit (JDK). Persons skilled in the art will appreciate that the JNI framework allows Java code that runs within a Java Virtual Machine (JVM) to operate with applications and libraries written in other languages, such as C, C++ and assembly, and visa versa. It thus provides interfaces whereby Java applications can utilize COM objects and COM applications can utilize Java objects. Although not shown, the Java/COM bridge 2, the COM application 4 and the Java application 6 could all execute on a single data processing platform running a single operating system. Alternatively, the Java/COM bridge 2 could be implemented as a distributed entity, such that the Java side thereof runs on one data processing platform in conjunction with the Java application 6, while the COM side thereof runs on another data processing platform in conjunction with the COM application 8.

The Java/COM bridge 2 can be implemented using existing Java/COM bridge technologies (JCBTs), such as the IBM® Rational Java-COM Bridge (RJCB), with appropriate modifications being made thereto according to the present invention. The Java runtime library 8 and the COM runtime library 10 can be respectively provided by Java Archive (.jar) files and Dynamic Link Library (.dll) files. These files contain supporting classes used by Java application 6 and the COM application 4.

COM interfaces typically provide two different method call mechanisms: early-bound and late-bound. The early-bound call mechanism requires that the address and parameter types associated with a called method be known at compile time. The late-bound call mechanism entails resolving method names at runtime and packaging or unpackaging all of the method parameters into or from a special variant array. A super-interface known as IDispatch is used to provide a method for looking up a COM interface's methods (or properties) symbolically by name and return a method identifier known as a DISPID. Using this information, a VB (Visual Basic®) or VBScript (Visual Basic® Script) GetObject( ) call, or a VC (Visual C++®) GoGetObject( ) call, can be used to invoke the COM interface method.

Conventional JCBTs provide late-bound COM-to-Java support on behalf of COM applications via the GetObject( ) call. As a prerequisite to a COM application's invocation of this late-bound call, the target Java application must register itself in a COM-side global look-up table known as the Running Object Table (ROT). The purpose of the ROT is to keep track of all identifiable COM objects that are currently running in an execution context within the COM environment. In a conventional JCBT environment, once a Java application has registered in the ROT, a COM application may call the GetObject( ) method while passing the unique Java application name and the name of a Java class in the application that is to be instantiated. The GetObject( ) call results in a lookup for the Java application's entry in the ROT. As described in more detail below, the ROT entry references a COM object that contains methods for parsing the GetObject( ) parameters, automatically instantiating the named Java class as an object in the running Java application, and returning an object that is a COM proxy for the instantiated Java object to the caller of GetObject( ). Via the returned COM proxy object, also known as a COM-callable wrapper, it is then possible for the COM application to reference methods and fields of the associated Java object.

By way of example, assume that there is a hypothetical Java class “Foo” of a hypothetical Java application called “MyServer” that relies on a hypothetical Java package called “com.xxx.foo.” In order to instantiate Foo and then call one of Foo's methods (known as “someMethod”), a COM application would make the following calls:

Set fooObj=GetObject(“MyServer:com.xxx.foo.Foo”)

fooObj.someMethod

In a conventional JCBT system, the Foo class object in the above example must be capable of instantiation and must have a public parameterless constructor. If it does not (i.e., it only has constructors with parameters), the class cannot be instantiated with existing bridging technologies. Moreover, if the Foo class has static methods or fields that need to be referenced, existing bridging technologies only allow such entities to be called if Foo is first instantiated.

The present invention provides a solution to this problem so that COM applications can reference static Java methods and fields without requiring an object instance, and so that COM applications can instantiate Java classes using constructors that take parameters. The foregoing is achieved in part by modifying the bridging technology so that it registers a modified entry in the ROT that recognizes a special suffix to the named Java class in the GetObject( ) call. This special suffix indicates that a static COM proxy object for the named Java class is required and that the named class should not be instantiated. The static object returned by GetObject( ) can then be used to reference static methods and fields.

Using the example given above, the COM application would issue the following modified GetObject( ) call to invoke a static method of the Foo class without instantiation:

Set Foo=GetObject(“MyServer:com.xxx.foo.Foo.static”)

Foo.someStaticMethod

In the foregoing example, the static COM proxy object returned by the GetObject( ) call is named “Foo.” The COM application uses this static COM proxy object to call the static method “someStaticMethod” without ever having to instantiate the Foo class.

The same static COM proxy object can also be used to create instances of the Foo class using its constructors that take parameters. For example, if the Foo class had a constructor that takes a string and a boolean, this class could be instantiated using the static COM proxy (“Foo”) returned by GetObject( ) in the example above, as follows:

Set fooObj=Foo(“MyFoo”, True)

The foregoing call invokes the “default” method of the Foo static COM proxy object. The Java/Com bridge 2 automatically determines that the default method is the Foo constructor that takes a string and a boolean.

II. Conventional Late Bound COM-to-Java Support Technique

The modifications used by the Java/COM bridge 2 to implement the foregoing static COM proxy functionality according to the present invention can be best understood by considering the details of how a prior art COM proxy object is generated in response to the GetObject( ) call in a conventional JCBT system, as follows:

1. ROT Registration

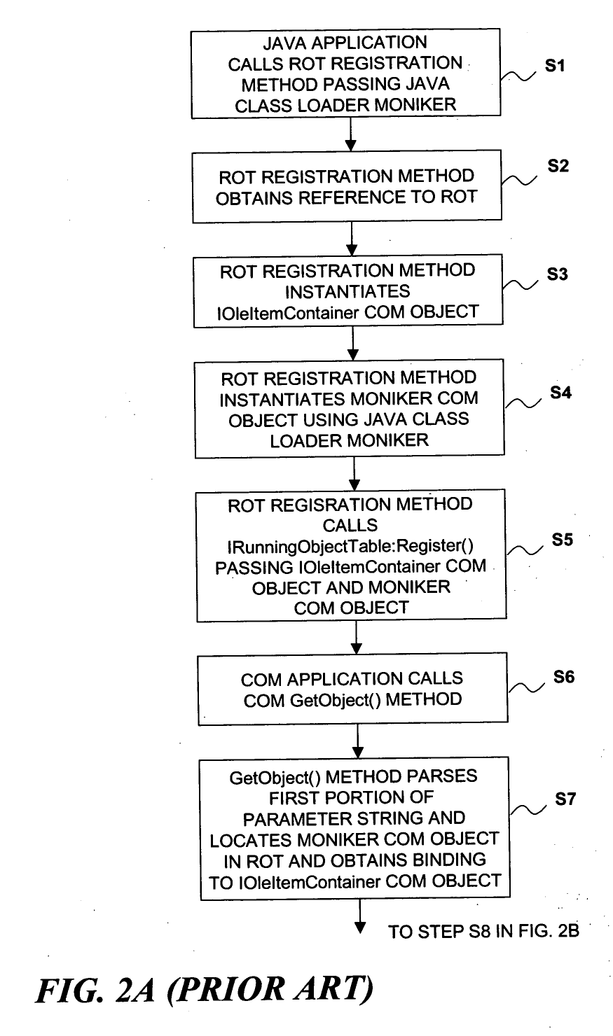

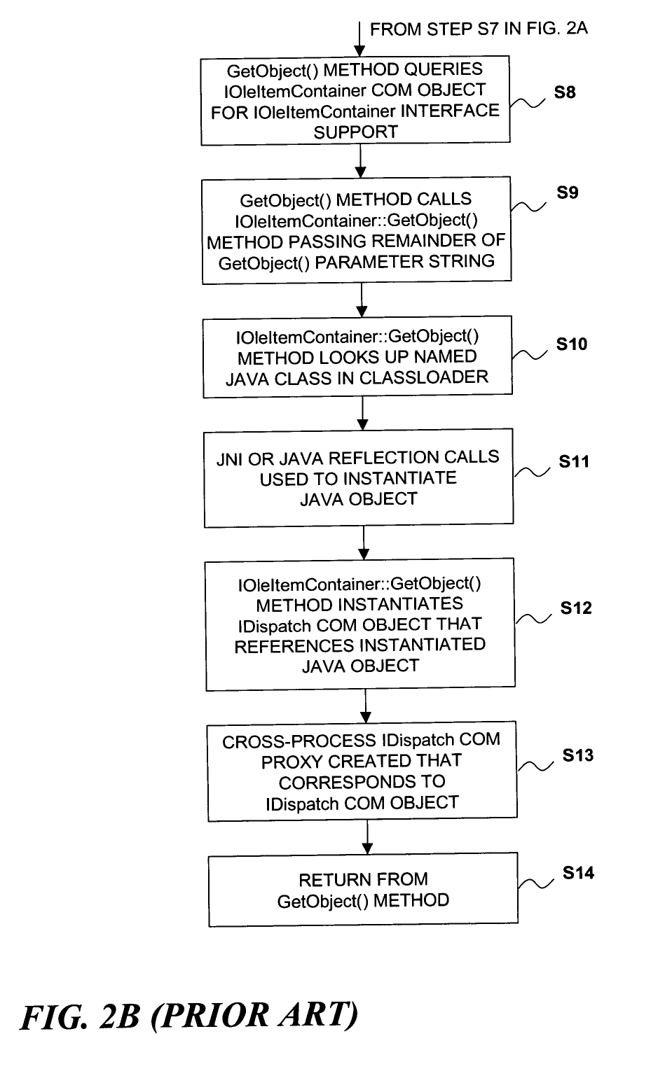

As summarized above, and with additional reference now to the flow diagram of FIG. 2, a first step (S1) in providing late bound COM-to-Java support in a conventional JCBT is for a Java application to call a registration method defined by the Java runtime library provided by the JCBT being used. Different JCBTs have different names for their registration method, but for the sake of the present discussion, this registration method will be called “registerlnROT.” An example of how the Java application makes this call is as follows:

registerInROT(“MyServer”);

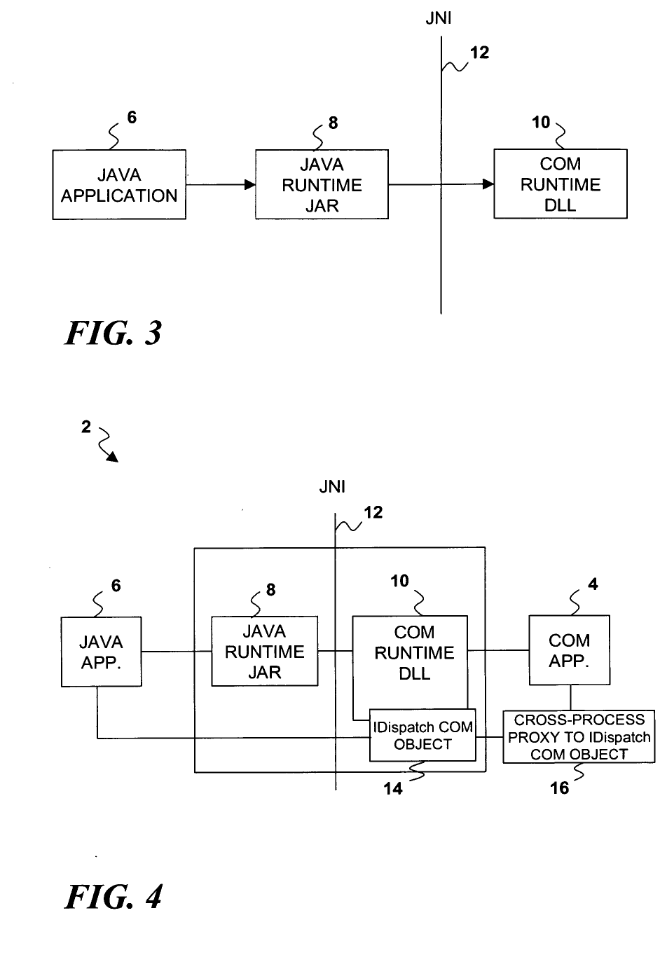

The registerInROT( ) method is implemented as a JNI method whose body is defined in the JCBT's COM runtime native code. In the context of the Java/COM bridge 2 of FIG. 1, the flow of execution is from the Java application 6, through the Java runtime library 8, to the COM runtime library 10, as shown in FIG. 3.

The registerInROT( ) method of a conventional JCBT system implements the following steps (S2-S5 of FIG. 2) using conventional COM interfaces and win32 methods, all of which are well documented within the Microsoft® MSDN Library:
1. Obtain a reference to the COM running object table (ROT) (i.e. an IRunningObjectTable COM pointer) by calling the win32 method GetRunningObjectTable( ) (step S2 of FIG. 2).
2. Instantiate a COM object that implements the IOleltemContainer COM interface, which provides methods that allow this COM object to act as a container for named objects (in this case Java classes) that can be looked up and returned to the caller by name (step S3 in FIG. 2). In the registerInROT( ) method, this COM object is initialized so that it holds a reference to a Java classloader that it will use to lookup Java classes be exposed to the COM side of the JCBT. The classloader can either be user-defined, or it could be the root class loader associated with a JVM. For example, a simple implementation would just use the JVM's root classloader. In a more general solution, the Java application would pass the classloader of its choosing in its call to the registerInROT( ) method.
3. Instantiate a COM object that implements the IMoniker COM interface, which provides methods that allow this COM object to function as a moniker object that uniquely identifies and locates the IOleltemContainer COM object above (step S4 in FIG. 2). This COM object is instantiated by calling the win32 method CreateFileMoniker( ), passing as an argument the string parameter that was passed in the registerInROT( ) call. In the example above, this is the “MyServer” string.
4. Call the IRunningObjectTable::Register( ) method, passing the moniker and container COM objects instantiated above (step S5 in FIG. 2).

At this point in the conventional JCBT processing sequence, the Java application 6 is up and running and has registered an IOleItemContainer COM object in the ROT in association with the moniker COM object. The COM application 4 may now start up and use the VB GetObject( ) method (or VC CoGetObject( ) method (Step S6 in FIG. 2) to instantiate a Java class within the namespace defined by the Java classloader referenced by the IOleItemContainer COM object. An example call using the VB GetObject( ) method is as follows:

Set fooObj=GetObject(“MyServer:com.xxx.foo.Foo”)

The string passed to GetObject( ) is a composite moniker and has the syntax “<moniker>:<class-name>”. The <moniker>in this example is “MyServer” (i.e. the same moniker the Java application 6 used in its call to the registerInROT( ) method) and the <class-name>is “com.xxx.foo.Foo”.

The GetObject( ) method performs several conventionally known actions (steps S7-S13 in FIG. 2) to return a COM object proxy given the composite moniker it is passed as an argument, as follows:
5. The GetObject( ) method parses the composite moniker up to the colon (‘:’) and a COM object with that name (i.e., “MyServer”) is searched for in the ROT. The moniker COM object that was registered by the Java application 6 under “MyServer” is located and a binding to the IOleltemContainer COM object is obtained (step S7 in FIG. 2).
6. The IOleltemContainer COM object is queried to see if it implements the IOleltemContainer COM interface (which it does) (step S8 in FIG. 2).
7. The IOleItemContainer::GetObject( ) method is called by the main GetObject( ) method using the IOleItemContainer interface of the IOleItemContainer COM object. It passes the remainder of the composite moniker string (i.e. the portion after the colon representing the Java class name) to this method (Step S9 in FIG. 2).
   7.1 The IOleItemContainer COM object holds a reference to the Java classloader for the Foo class. The IOleItemContainer::GetObject( ) method executes on the Java side of the JCBT using JNI calls to look up the named class in the classloader on the Java side of the JCBT (step S10 in FIG. 2).
   7.2 JNI calls or a combination of JNI and Java reflection calls are used to instantiate (create an instance of) the named Java class (step S11 in FIG. 2).
   7.3. A COM object is instantiated that implements the IDispatch COM interface and initialized it so that it holds a reference to the newly instantiated Java object (step S12 in FIG. 2). This IDispatch COM object exists within the Java application process space and represents the return from the IOleItemContainer::GetObject( ) method.
8. The OS provided COM system automatically creates a cross-process COM proxy for the IDispatch COM object that the IOleItemContainer::GetObject( ) method returned (step S13 in FIG. 2). According to conventional JCBT processing, the main GetObject( ) method thus returns the IDispatch COM object back to the COM application 4 within the COM application process space and assigns it to the FooObj variable (Step S14 in FIG. 2). The fooObj variable has the COM created cross-process COM proxy as its value. FIG. 4 is illustrative. It shows the IDispatch COM object 14 returned by IOleItemContainer::GetObject( ) method (within the COM runtime environment 10 of Java/COM bridge 2) and the IDispatch COM proxy 16 returned by the main GetObject( ) call in the operating system supported COM environment that runs the COM application 4.

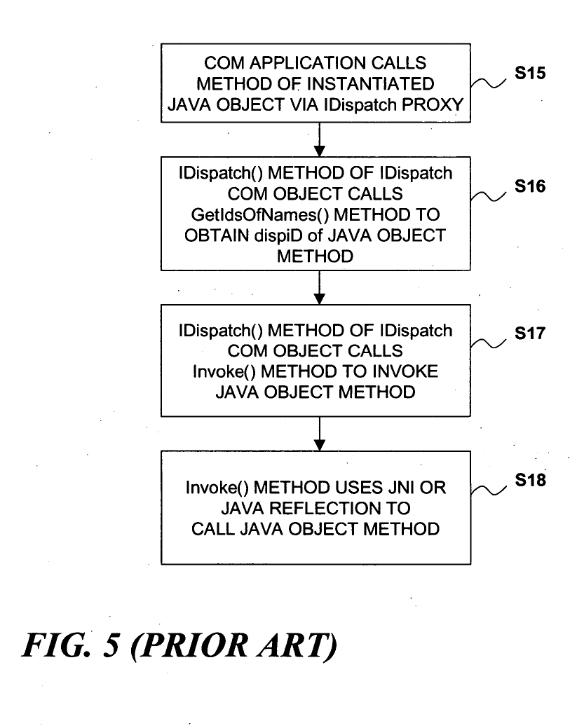

According to further conventional JCBT operations, and referring to the flow diagram of FIG. 5, the COM application can now make a late-bound call (step S15 in FIG. 5) to some method that is defined in the “com.ibm.foo.Foo” class, as follows:

fooObj.someMethod

Via conventional COM library methods, this call is dispatched across process boundaries and the IDispatch COM object 14 uses JNI or a combination of JNI and Java reflection in its IDispatch implementation to call the named method (i.e. when its implementation of the IDispatch methods GetIDsOfNames( ) and Invoke( ) are called) (steps S16-S18 in FIG. 5). As is conventionally known, the GetIDsOfNames( ) method identifies a named method by returning a “dispId” value (step S16 in FIG. 5). The dispId value is passed to the Invoke( ) method when this method is called (step S17 in FIG. 5). The Invoke( ) method uses JNI or a combination of JNI and Java reflection to call the named Java object method (step S18 in FIG. 5). Insofar as the IDispatch COM object 14 holds a reference to the Java object it represents, it uses this Java object when making the calls to the GetIDsOfNames( ) and Invoke( ) methods.

The JCBT runtime IDispatch implementation, of course, must deal with converting any parameters passed/returned (e.g. convert COM strings into Java strings, etc.). Conventional JCBT implementations use well known COM-defined and JNI-defined methods to implement these conversions. Typically, IDispatch implementations for a JCBT runtime also support referencing Java fields like COM properties.

As indicated in the introductory section above, in a conventional JCBT system, the “Foo” Java class object corresponding to the IDispatch COM proxy 16 must be capable of instantiation and must have a public parameterless constructor. If it does not (i.e., it only has constructors that require parameters), the class cannot be instantiated with existing bridging technologies. Moreover, if the Foo Java class has static methods or fields that need to be referenced, existing bridging technologies only allow such entities to be called if the Foo class is first instantiated.

III. Enhanced Late Bound COM-to-Java Support Via Static COM proxy

As briefly discussed above, the following code illustrates how the COM application 4 can implement the enhanced late-bound COM-to-Java support provided by the present invention to access a non-instantiated Java class and a static method thereof, and then instantiate the class using a parameterized constructor call:

Set Foo=GetObject(“MyServer:com.xxx.foo.Foo.static”)

Foo.someStaticMethod

Set fooObj=Foo(“My Foo”, True)

In this example, because the “.static” suffix was specified, the GetObject( ) call does not create an instance of the Java class “com.xxx.foo.Foo” and return a dispatch proxy to it. Instead, it creates a static dispatch proxy to the class itself. Using this static dispatch proxy, the COM application 4 can call static methods or reference static variables of the Foo class. In addition, the COM application 4 can instantiate the Foo class using one of its constructors that takes parameters. In the example above, the Foo class has a constructor that takes two parameters: a string and a boolean.

The Java/COM bridge 2 modifies three aspects of the conventional JCBT late bound COM-to-Java technique described above, as follows:
1. The GetObject( ) method is modified to provide support for recognizing the “.static” suffix.
2. The IDispatch COM object 14 and its IDisplatch COM proxy 16 (FIG. 4) are modified to provide support for calling static methods and referencing static fields.
3. The IDispatch COM object 14 and its IDispatch COM proxy 16 (FIG. 4) are modified to provide support for instantiating a Java object using a class constructor that takes arguments.

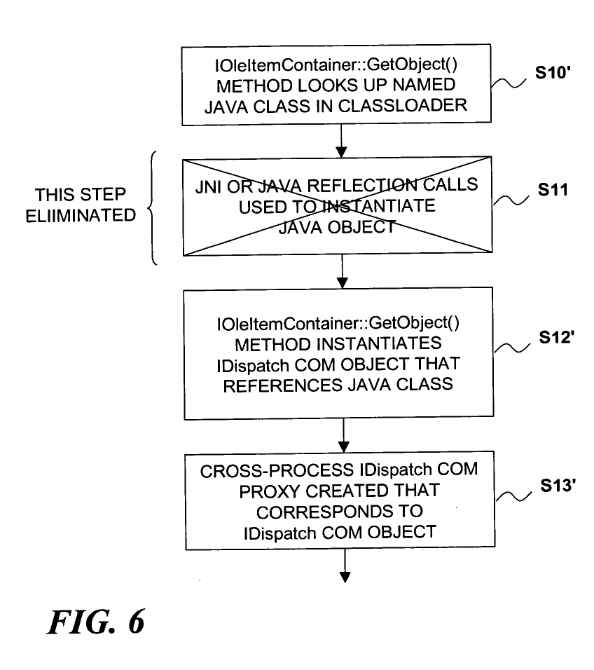

To implement the enhanced GetObject( ) support that recognizes the “.static” suffix involves modifications of several steps that occur in the IOleItemContainer::GetObject( ) implementation (i.e. steps 7 and 8 in section II above; steps S1O-S13 of FIG. 2) whenever the string passed to the IOleItemContainer::GetObject( ) method ends with the suffix “.static.” These modified steps are shown in Steps S10′-S13′ of FIG. 6:
1. The IOleItemContainer::GetObject( ) method looks up the specified Java class in the classloader (step S10′ in FIG. 6), but does not create an instance of the Java class (step S11 of FIG. 2 is eliminated).
2. The IOleItemContainer::GetObject( ) instantiates the IDispatch COM object 14 and initializes it as a static COM object so that it holds a reference to the named Java class (not an instance of that Java class) (step S12′ in FIG. 6).
3. This IDispatch static COM object 14 is returned as the result for the IOleItemContainer::GetObject( ) call, and the IDispatch COM proxy 16 is created as a static COM proxy (step S13′ in FIG. 6). At this point, the COM application 4 has an object (the COM proxy 16) that it can use for call static methods or reference static variables of the Foo class. By eliminating step S11, the need for JNI or Java reflection calls at this point has also been avoided, thereby potentially improving processing efficiency.

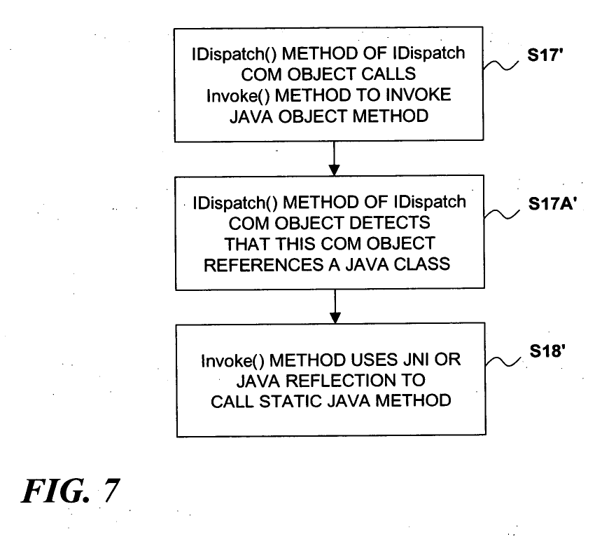

To implement the enhanced IDispatch COM object support for calling static methods and referencing static fields, the IDispatch::Invoke( ) method of the IDispatch COM object 14 (steps S17-S18 of FIG. 5) is modified in the manner shown by steps S17′-S18′ in FIG. 7 to operate as follows:
1. After being called in step S17′ of FIG. 7, the IDispatch::Invoke( ) method detects that the IDispatch COM object 14 is a static dispatch proxy that holds a reference to a Java class, not a reference to an instance of that class (step S17A′ of FIG. 7).
2. The IDispatch::Invoke( ) method uses the appropriate JNI or a combination of JNI and Java reflection interfaces for calling static methods and referencing static fields of the Java class to which it holds a reference (step S18′ of FIG. 7).

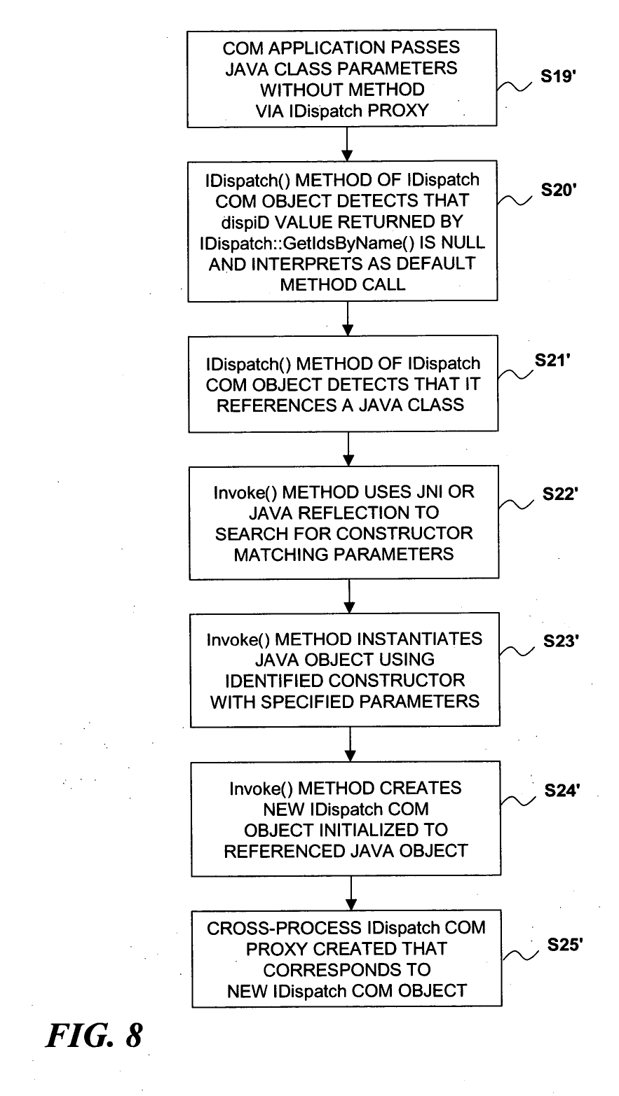

With additional reference now to the flow diagram of FIG. 8, to implement the enhanced IDispatch COM object support for instantiating a Java object using a class constructor that takes arguments, the IDispatch::Invoke( ) method of the IDispatch COM object 14 is enhanced as follows:
1. After the COM application 4 passes Java class parameters without identifying a method (step S19′ in FIG. 8), the IDispatch::Invoke( ) method detects when the dispId parameter has the value zero as a result of the COM application 4 calling a java class with parameters but without specifying a class method (as in Set fooObj=Foo(“My Foo”, True)), which indicates that the default method should be invoked (step S20′ in FIG. 8). The IDispatch::Invoke( ) method also detects that the IDispatch COM object 14 is a static dispatch proxy that holds a reference to a Java class, not a reference to an instance of that class (step S21′ in FIG. 8).
2. Using JNI and Java reflection, the IDispatch::Invoke( ) method searches for a constructor (in the Java class to which it holds a reference) that matches the given parameters (e.g., using conventional overload resolution that takes into account the number and types of the specified parameters in the Set fooObj=Foo(“My Foo”, True) call) class (step S22′ in FIG. 8).
3. If it finds an appropriate constructor, the IDispatch::Invoke( ) method creates an instance of the Java class using the matching constructor and the specified arguments (step S23′ in FIG. 8).
4. The IDispatch::Invoke( ) method then creates a new IDispatch COM object that is initialized so that it holds a reference to the newly instantiated Java object (step S24′ in FIG. 8). A new cross-process IDispatch COM proxy for the newly instantiated static COM object is then returned as the result of the IDispatch::Invoke( ) method (step S25′ in FIG. 8).

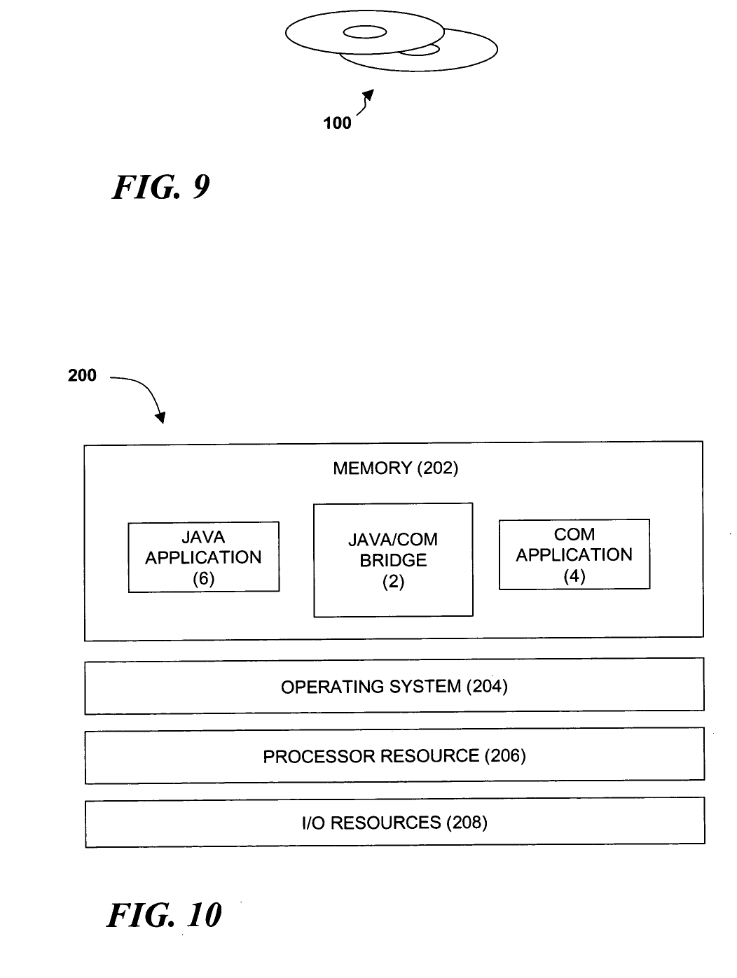

Accordingly, a Java/COM bridge providing enhanced late-bound COM-to-Java® support has been disclosed. It will be appreciated that the inventive concepts may be variously embodied in any of a machine implemented method, a data processing system and a computer program product in which programming means are provided by one or more machine-useable media for use in controlling a data processing system to perform the required functions. Exemplary machine-useable media for providing such programming means are shown by reference numeral 100 in FIG. 9. The media 100 are shown as being portable optical storage disks of the type that are conventionally used for commercial software sales, such as compact disk-read only memory (CD-ROM) disks, compact disk-read/write (CD-R/W) disks, and digital versatile disks (DVDs). Such media can store the programming means of the invention, either alone or in conjunction with another software product that incorporates the required functionality. The programming means could also be provided by portable magnetic media (such as floppy disks, flash memory sticks, etc.), or magnetic media combined with drive systems (e.g. disk drives), or media incorporated in data processing platforms, such as random access memory (RAM), read-only memory (ROM) or other semiconductor or solid state memory. More broadly, the media could comprise any electronic, magnetic, optical, electromagnetic, infrared, semiconductor system or apparatus or device, transmission or propagation medium (such as a network), or other entity that can contain, store, communicate, propagate or transport the programming means for use by or in connection with a data processing system, computer or other instruction execution system, apparatus or device. An exemplary data processing system 200 implementing a Java/COM bridge according to the invention is shown in FIG. 10. The Java/COM bridge 2, the COM application 4 and the Java application 6 of FIG. 1 are loaded in a memory 202 by an operating system 204. The Java/COM bridge 2, the COM application 4, the Java application 6, and the operating system 204 execute on a processor resource 206 comprising one or more processors. Conventional Input/Output resources 208 are provided for transferring information between the data processing system 200 and peripheral devices, components, and systems (not shown).

Although various embodiments of the invention have been described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A Java/COM bridge method providing enhanced late-bound COM-to-Java support, comprising:
receiving a late bound call from a COM application to a Java class in a Java application;
said late bound call containing a parameter indicating that said Java class should not be instantiated; and
returning to said COM application a static COM proxy representing said Java class without instantiating said Java class.

2. A method in accordance with claim 1 further including receiving a static method call from said COM application using said static COM proxy and invoking a static method of said Java class.

3. A method in accordance with claim 1 further including receiving a static method call from said COM application using said static COM proxy and referencing a static variable of said Java class.

4. A method in accordance with claim 1 further including receiving parameters from said COM application without a Java class method being specified and instantiating said Java class using a constructor of said Java class that takes said parameters.

5. A method in accordance with claim 1 further including said Java application creating and registering a COM container object in a COM running object table, said COM container object maintaining a reference to a Java classloader that loads said Java class and including a method for instantiating a static COM object corresponding to said static COM proxy and initializing said static COM object so that it holds a reference to said Java class without instantiating said Java class.

6. A method in accordance with claim 5 wherein said static COM object further includes a method for calling static methods of said Java class.

7. A method in accordance with claim 5 wherein said static COM object further includes a method for referencing static variables of said Java class.

8. A method in accordance with claim 5 wherein static COM object further includes a method for receiving parameters specified by said COM application without identifying a method, searching for a constructor in said Java class that takes said parameters, instantiating a Java object from said Java class using said constructor and said parameters, and returning a COM proxy referencing said instantiated Java object.

9. A computer program product for providing a Java/COM bridge with enhanced late-bound COM-to-Java support, comprising:
one or more machine-useable media;
means provided by said one or more machine-useable media for programming a data processing platform to operate as by:
receiving a late bound call from a COM application to a Java class in a Java application;
said late bound call containing a parameter indicating that said Java class should not be instantiated; and
returning to said COM application a static COM proxy representing said Java class without instantiating said Java class.

10. A computer program product in accordance with claim 9 further including programming for receiving a static method call from said COM application using said static COM proxy and invoking a static method of said Java class.

11. A computer program product in accordance with claim 9 further including programming for receiving a static method call from said COM application using said static COM proxy and referencing a static variable of said Java class.

12. A computer program product in accordance with claim 9 further including programming for receiving parameters from said COM application without a Java class method being specified and instantiating said Java class using a constructor of said Java class that takes said parameters.

13. A computer program product in accordance with claim 9 further including programming for said Java application creating and registering a COM container object in a COM running object table, said COM container object maintaining a reference to a Java classloader that loads said Java class and including a method for instantiating a static COM object corresponding to said static COM proxy and initializing said static COM object so that it holds a reference to said Java class without instantiating said Java class.

14. A computer program product in accordance with claim 13 wherein said static COM object further includes a method for calling static methods of said Java class.

15. A computer program product in accordance with claim 13 wherein said static COM object further includes a method for referencing static variables of said Java class.

16. A computer program product in accordance with claim 13 wherein static COM object further includes a method for receiving parameters specified by said COM application without identifying a method, searching for a constructor in said Java class that takes said parameters, instantiating a Java object from said Java class using said constructor and said parameters, and returning a COM proxy referencing said instantiated Java object.

17. A data processing system implementing a Java/COM bridge with enhanced late-bound COM-to-Java support, comprising:
Java application means for implementing a Java class;
COM application means for issuing a late bound call to said Java class;
a COM container object registered in a COM running object table, said COM container object maintaining a reference to a Java classloader that loads said Java class and including a method for instantiating a static COM object corresponding to said static COM proxy and initializing said static COM object so that it holds a reference to said Java class without instantiating said Java class.

18. A system in accordance with claim 17 wherein said static COM object further includes a method for calling static methods of said Java class.

19. A system in accordance with claim 17 wherein said static COM object further includes a method for referencing static variables of said Java class.

20. A system in accordance with claim 17 wherein static COM object further includes a method for receiving parameters specified by said COM application without a method, searching for a constructor in said Java class that takes said parameters, instantiating a Java object from said Java class using said constructor and said parameters, and returning a COM proxy referencing said instantiated Java object.
